(19) United States
(12) Patent Application Publication
(10) Pub. No.: US 2021/0232122 A1
(43) Pub. Date: Jul. 29, 2021

(54) MANAGEMENT DEVICE, MANAGEMENT METHOD, AND PROGRAM

(71) Applicant: Mitsubishi Electric Corporation, Tokyo (JP)

(72) Inventor: Osamu NASU, Tokyo (JP)

(73) Assignee: Mitsubishi Electric Corporation, Tokyo (JP)

(21) Appl. No.: 17/051,189

(22) PCT Filed: Jun. 22, 2018
(86) PCT No.: PCT/JP2018/023751

§ 371 Date: Oct. 28, 2020

(51) Int. Cl. G05B 19/4155; G06F 9/445

(52) U.S. Cl. CPC G05B 19/4155; G06Q 10/06395; G06F 9/445

(57) ABSTRACT

The management device (10) is connected to a plurality of devices (20), and includes a first receiver (150) to receive a setting of processing to be performed on data output from at least one of the plurality of devices (20), an execution controller (120) to cause a processing unit (110) to execute the processing with the setting received by the first receiver (150), a second receiver (170) to receive a setting of a hierarchical relationship of the plurality of devices (20), and a device manager (180) to provide management information for displaying (i) the hierarchical relationship of the plurality of devices (20) according to the setting received by the second receiver (170) and (ii) information related to an execution state of the processing.

### TECHNICAL FIELD

The present disclosure relates to a management device, a management method, and a program.

### BACKGROUND ART

In facilities such as factories, systems are formed in which a plurality of devices are connected by a network. Typically, a management device for managing the devices is provided to operate the system (for example, see Patent Literature 1). Patent Literature 1 describes a technique for managing the hierarchy of plants including devices and a facility system including plants as objects that form tree-structure hierarchies.

### CITATION LIST

### Patent Literature

Patent Literature 1: Unexamined Japanese Patent Application Publication No. 2004-252700

### SUMMARY OF INVENTION

### Technical Problem

In systems such as that described above, processing including modifying and diagnosing of data collected from the plurality of devices is sequentially performed on the data. However, there is a demand to realize a flexible process flow by enabling a user to combine, as desired, processes to be performed on the data. To answer this demand, a technique in which a user executes a process flow that is set as desired has been considered. In a case in which the user sets the process flow, the user must manage the devices as described above and, at the same time, also manage the process flow set by the user. However, when the number of devices is great and the process flow is complex, the management burden of the user may become excessively heavy.

The present disclosure is made with the view of the above situation, and an objective of the present disclosure is to lighten the management burden of the user.

### Solution to Problem

In order to achieve the aforementioned objective, a management device of the present disclosure is a management device to be connected to a plurality of devices, the management device including first reception means for receiving a setting of processing to be performed on data output from at least one of the plurality of devices, execution control means for causing processing means to execute the processing with the setting received by the first reception means, second reception means for receiving a setting of a hierarchical relationship of the plurality of devices, and device management means for providing management information for displaying (i) the hierarchical relationship of the plurality of devices according to the setting received by the second reception means and (ii) information related to an execution state of the processing.

### Advantageous Effects of Invention

According to the present disclosure, management information for displaying the hierarchical relationship of a plurality of devices, and for displaying information about the execution state of the processing is provided. As such, the user can easily manage a plurality of devices along with the execution state of the processing related to the plurality of devices. As a result, the management burden of the user can be lightened.

### BRIEF DESCRIPTION OF DRAWINGS

FIG. 1 is a block diagram illustrating the configuration of a management system according to an embodiment of the present disclosure;

FIG. 2 is a drawing illustrating an example of a process flow according to the embodiment;

FIG. 3 is a drawing illustrating an example of a system configuration according to the embodiment;

FIG. 4 is a drawing illustrating the hardware configuration of a management device according to the embodiment;

FIG. 5 is a drawing illustrating the functional configuration of the management device according to the embodiment;

FIG. 6 is a drawing illustrating an example of flow setting information according to the embodiment;

FIG. 7 is a drawing illustrating the configuration of a device manager according to the embodiment;

FIG. 8 is a drawing illustrating an example of management information according to the embodiment;

FIG. 9 is a drawing illustrating a data structure of the management information according to the embodiment;

FIG. 10 is a flowchart illustrating management processing according to the embodiment;

FIG. 11 is a drawing illustrating an example of a process flow setting screen according to the embodiment;

FIG. 12 is a drawing illustrating an example of a system configuration setting screen according to the embodiment;

FIG. 13 is a flowchart illustrating flow execution processing according to the embodiment;

FIG. 14 is a flowchart illustrating execution control processing according to the embodiment;

FIG. 15 is a drawing illustrating an example of flow data according to the embodiment;

FIG. 16 is a flowchart illustrating partial processing according to the embodiment;

FIG. 17 is a first drawing for explaining a new setting of the process flow according to the embodiment;

FIG. 18 is a second drawing for explaining a new setting of the process flow according to the embodiment;

FIG. 19 is a flowchart illustrating device management processing according to the embodiment;

FIG. 20 is a drawing for explaining a new setting of the management information according to the embodiment;

FIG. 21 is a drawing illustrating a display example of the management information according to the embodiment;

FIG. 22 is a drawing illustrating another example of the management information according to the embodiment;

FIG. 23 is a drawing illustrating the functional configuration of a management device according to a modified example of the embodiment;

FIG. 24 is a drawing illustrating the configuration of a device manager according to a modified example of the embodiment; and

FIG. 25 is a drawing for explaining processing units and a device manager according to a modified example of the embodiment.

### DESCRIPTION OF EMBODIMENTS

Hereinafter, a management system 100 according to an embodiment of the present disclosure is described in detail while referencing the drawings.

### EMBODIMENTS

The management system 100 according to the present embodiment is a factory automation (FA) system to be installed in a factory, and corresponds to a production system for producing products. The management system 100 performs various processes such as machining, monitoring, and inspecting workpieces flowing on a line X that is a manufacturing line. Moreover, the management system 100 has a function of providing management information for a user U1 to manage the state of the processing.

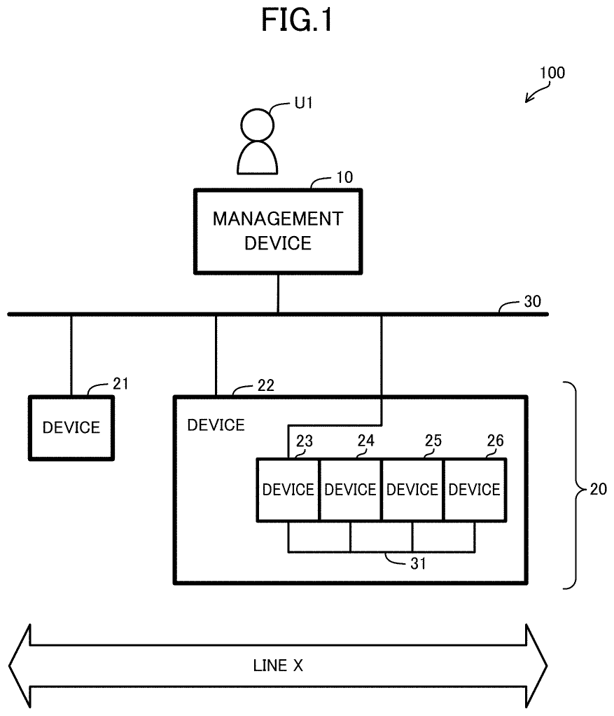

As illustrated in FIG. 1, the management system 100 includes a management device 10 that manages devices 21, 22, 23,24, 25, 26, and devices 21, 22 that are connected to the management device 10 via a communication path 30. The device 22 includes the device 23 that is connected to the management device 10 via the communication path 30, and the devices 24, 25, 26 that are connected to the device 23 via a bus 31.

The communication path 30 connects the management device 10 and the devices 21 to 23 so as to enable communication between the management device 10 and the devices 21 to 23. The communication path 30 connects the management device 10 and the devices 24 to 26 so as to enable communication between the management device 10 and the devices 24 to 26 via the device 23 that is connected to the communication path 30. The communication path 30 is an industrial control network realized by communication lines installed in the factory. However, the communication path 30 may be implemented as an information network such as a local area network (LAN). Additionally, the communication path 30 may be implemented as a dedicated line.

The devices 21 to 26 are devices such as actuators, robots, or sensor devices installed on the line X. In the following, an example is described in which the devices 23 to 26 of the device 22 are sensor devices, the device 23 outputs a measurement value indicating X-axis vibration, the device 24 outputs a measurement value indicating Y-axis vibration, the device 25 outputs a measurement value indicating Z-axis vibration, and the device 26 outputs a measurement value of a housing temperature. The devices 22 to 26 periodically output, to the management device 10, data that indicates measurement results by the sensors. For example, the cycle on which the devices 22 to 26 output the measurement results is 1 ms, 100 ms, or 1 sec. In the following, the devices 21 to 26 are collectively referred to as “devices 20.”

The management device 10 is implemented as an industrial computer to be installed in the factory. The management device 10 executes control processing for using the devices 21 to 26 to run the line X. This control processing is a process flow that the user U1 designs by combining, as desired, one or more partial processes. Additionally, the management device 10 provides a management screen for the user U1 to manage the configuration of the management system 100. Furthermore, in addition to the configuration of the management system 100, the management device 10 displays an execution state of the process flow on this management screen.

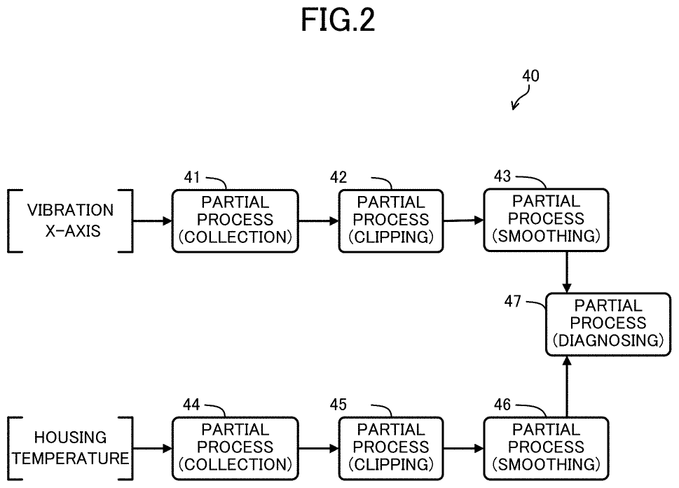

FIG. 2 illustrates a process flow 40 executed by the management device 10. The process flow 40 includes a series of partial processes 41, 42, 43, 44, 45, 46, 47 to be performed on data collected from the devices 22, 23.

The partial process 41 corresponds to processing for collecting data from the device 22, and the partial process 42 corresponds to processing for clipping the data output as the result of the partial process 41. The data clipping processing is processing for rounding values to a predefined range. The partial process 43 corresponds to processing for smoothing the data output as the result of the partial process 42. In one example, the data smoothing is carried out by a moving average or infinite impulse response (IIR) filter. The partial process 44 corresponds to processing for collecting data from the device 23, the partial process 45 corresponds to processing for clipping the data output as the result of the partial process 44, and partial process 46 corresponds to processing for smoothing the data output as the result of the partial process 45. The partial process 47 corresponds to processing for diagnosing the data output as the result of the partial processes 43, 46. The data diagnosing processing is processing for diagnosing, based on a comparison with a predetermined normal pattern, whether there is an abnormality.

According to the process flow 40 illustrated in FIG. 2, the series of processes including the partial processes 41 to 47 is executed each time measurement results are output form the devices 22, 23. Whether there is an abnormality is diagnosed based on a value obtained by removing outliers included in the measurement results by the clipping and reducing noise by the smoothing, and the user U1 is notified of the diagnosis results.

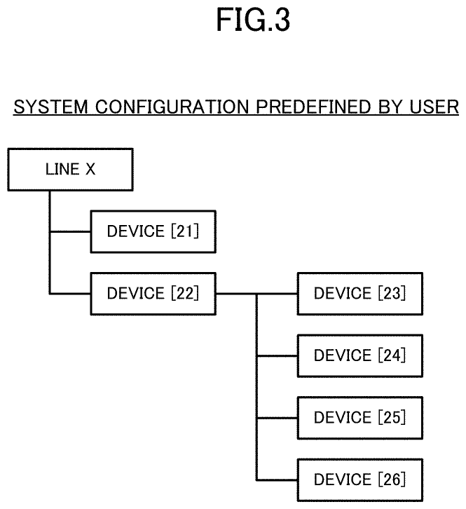

The management device 10 provides, to the user U1, a screen such as illustrated in FIG. 3 for managing the configuration of the management system 100. This system configuration illustrates the hierarchical structure of the management system 100 and is defined as desired by the user so as to indicate the hierarchical relationships between the devices. For example, in FIG. 3, a relationship is illustrated in which the devices 23 to 26 are subordinate to the device 22. Moreover, the management device 10 displays such a system configuration to the user in a tree-form, thereby making it possible to easily acquire and edit information related to each of the devices. Note that, in FIG. 3, the numbers in brackets after “device” are the same as the reference numeral of each of the devices 20. For example, “device [21]” corresponds to device 21. The system configuration is defined as desired by the user U1, regardless of the actual physical connection relationships of the plurality of devices 20.

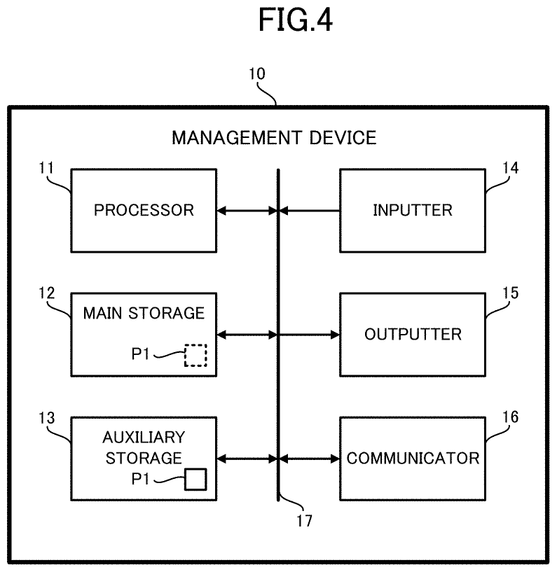

Next, the hardware configuration of the management device 10 is described. As illustrated in FIG. 4, the management device 10 includes a processor 11, a main storage 12, an auxiliary storage 13, an inputter 14, an outputter 15, and a communicator 16. The main storage 12, the auxiliary storage 13, the inputter 14, the outputter 15, and the communicator 16 are each connected to the processor 11 via an internal bus 17.

The processor 11 includes a micro processing unit (MPU). The processor 11 executes a program P1 stored in the auxiliary storage 13 to realize the various functions of the management device 10 and execute processing (described later).

The main storage 12 includes random access memory (RAM). The program P1 is loaded into the main storage 12 from the auxiliary storage 13. Moreover, the main storage 12 is used as the working area of the processor 11.

The auxiliary storage 13 includes non-volatile memory such as electrically erasable programmable read-only memory (EEPROM). In addition to the program P1, the auxiliary storage 13 stores various pieces of data used in the processing of the processor 11. In accordance with commands from the processor 11, the auxiliary storage 13 supplies data to be used by the processor 11 to the processor 11, and stores data supplied from the processor 11.

The inputter 14 includes an input device such as an input key and a pointing device. The inputter 14 acquires information input by the user U1 of the management device 10, and notifies the processor 11 of the acquired information.

The outputter 15 includes an output device such as a liquid crystal display (LCD) and a speaker. The outputter 15 constitutes a touch screen that is formed integrally with the pointing device that constitutes the inputter 14. The outputter 15 presents various pieces of information to the user U1 in accordance with commands from the processor 11.

The communicator 16 includes a network interface circuit for communicating with an external device. The communicator 16 receives an external signal and outputs data expressed by that signal to the processor 11. The communicator 16 sends a signal expressing data output from the processor 11 to the external device.

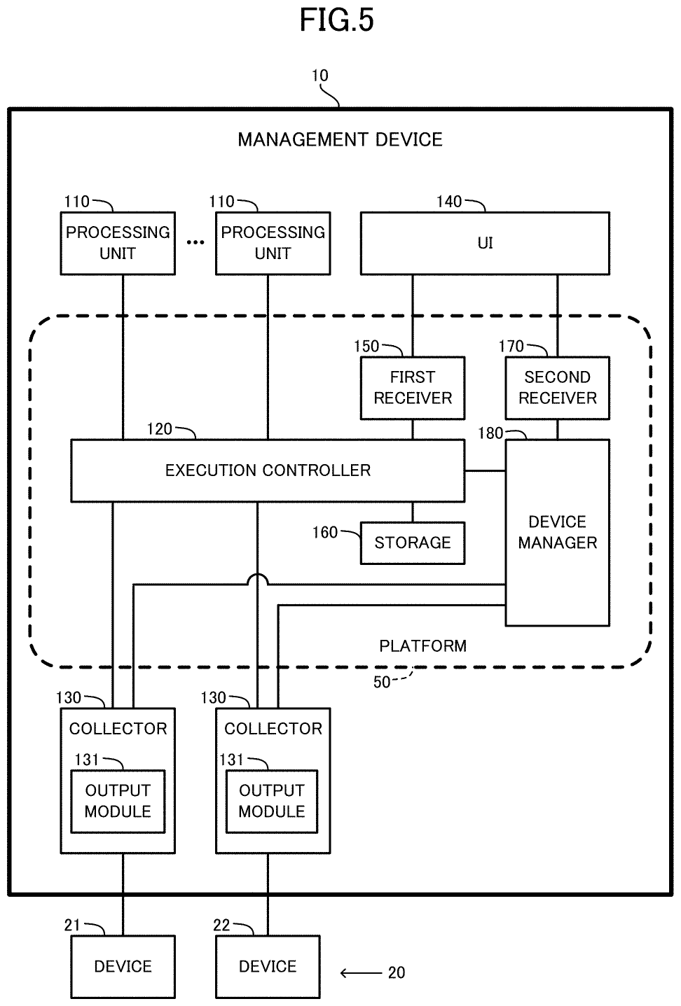

The hardware components described above cooperate and, as a result, the management device 10 achieves various functions. As illustrated in FIG. 5, the management device 10 includes, as such functions, processing units 110 that execute the partial processes of the process flow, an execution controller 120 that causes the processing units 110 to execute the partial processes, collectors 130 that collect data output from the devices 20, a user interface (UI) 140 for exchanging information with the user, a first receiver 150 that receives settings of the process flow, a storage 160 that stores various pieces of data, a second receiver 170 that receives settings of the hierarchical relationships of the devices 20, and a device manager 180 that provides the user U1 with management information for managing the devices 21 to 26.

The execution controller 120, the first receiver 150, the storage 160, the second receiver 170, and the device manager 180 form a platform 50 for executing the process flow and managing the system configuration.

The processing units 110 are realized mainly by the processor 11. Each of the processing units 110 is realized by the program P1 preset in the management device 10 or plug-in software prepared by the user. Each of the processing units 110 executes the partial processes that are elements of the process flow. Specifically, each of the processing units 110 acquires, as the subject of the partial process, data input by the execution controller 120, and outputs the results of performing the partial process on the acquired data to the execution controller 120. In the example illustrated in FIG. 2, each of the partial processes 42, 43, and 45 to 47 is realized by one of the processing units 110. The processing units 110 function as the processing means recited in the claims.

The execution controller 120 is realized mainly by the processor 11. The execution controller 120 causes the processing units 110 to execute the partial processes in order according to the settings received by the first receiver 150. Specifically, the execution controller 120 acquires the data collected by the collectors 130, and outputs the acquired data to the processing unit 110 that performs a partial process on that data. Additionally, the execution controller 120 acquires data output as the result of the partial process from the processing unit 110, and sends the acquired data to the processing unit 110 that performs the next partial processes on that data, or to an output module 131, which outputs that data, of the collector 130. The execution controller 120 functions as the execution control means recited in the claims.

The collectors 130 are realized mainly by cooperation between the processor 11 and the communicator 16. In FIG. 5, two collectors 130 are provided in correspondence with the devices 21, 22. However, a collector 130 may be provided for each transmission path that connects to the management device 10. A collector 130 collects the data output from the device 22 to which the collector 130 is connected, and sends the collected data to the execution controller 120. The collectors 130 function as the collection means recited in the claims.

The collectors 130 each include an output module 131 that outputs output information. The output information is information related to the execution results of the process flow. For example, in a case in which a process flow for controlling the device 21 is executed, the output module 131 sends, as the output information to the device 21 to be controlled, a command signal sent from the execution controller 120. Note that the output information is not limited to a control signal, and may be a notification for reporting the occurrence of an abnormality, or may be quality control information to be stored in an external server device.

The UI 140 corresponds to a touch screen that is realized mainly by the inputter 14 and the outputter 15. The UI 140 displays, in accordance with control by the first receiver 150, a screen to the user for inputting the settings of the process flow. The user operates the UI 140 to set, as desired, the content and number of partial processes of the process flow, and parameters necessary for the execution of the partial processes. Moreover, the UI 140 sends, to the first receiver 150, information indicating the settings of the process flow input by the operations of the user. Additionally, the UI 140 displays, in accordance with control of the device manager 180 via the second receiver 170, a screen to the user for inputting the system configuration including the hierarchical relationships of the devices 20. The user operates the UI 140 to set the system configuration as desired. Moreover, the UI 140 sends, to the second receiver 170, information indicating the settings of the system configuration input by the operations of the user.

The first receiver 150 is realized mainly by the processor 11. The first receiver 150 receives the settings of the process flow from the UI 140, and reports flow setting information indicating the setting content to the execution controller 120. The flow setting information reported to the execution controller 120 is stored in the storage 160. The first receiver 150 functions as the first reception means recited in the claims.

The storage 160 is realized mainly by the auxiliary storage 13. The storage 160 stores the flow setting information.

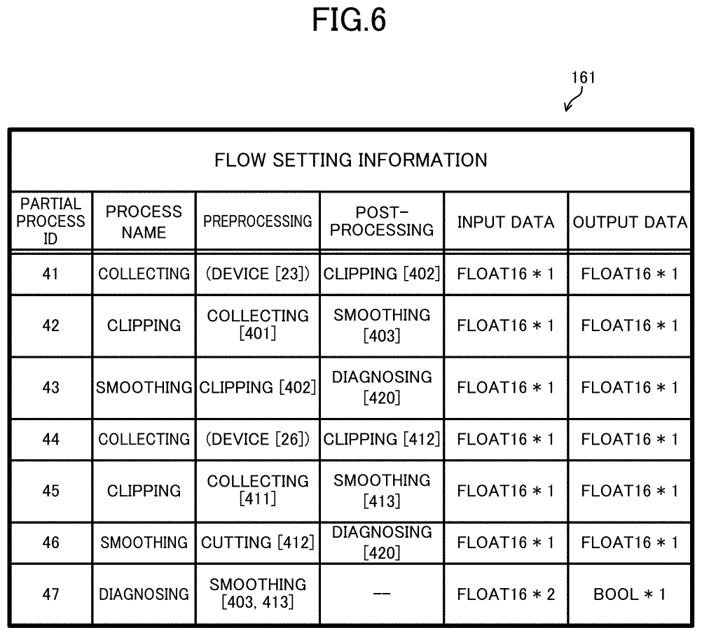

FIG. 6 illustrates an examples of flow setting information 161 stored in the storage 160. This flow setting information 161 indicates the settings for executing the process flow illustrated in FIG. 2. The flow setting information 161 is a data table in which a partial process ID for identifying a partial process, a name of the partial process, a partial process corresponding to preprocessing of the partial process, a partial process corresponding to post-processing of the partial process, a type of the data input in the partial process, and a type of the data output from the partial process are associated.

In FIG. 6, the partial process ID is an identifier equivalent to the reference numeral assigned to the partial processes in FIG. 2. Additionally, the numbers of the preprocessing and the post-processing indicate the partial process ID. The devices 20 that output the data to be collected are indicated as the preprocessing of the partial process called “Collecting.” Regarding the input data and the output data, “FLOAT16*1” means that there is one piece of floating point-type 16-bit data. Likewise, “FLOAT16*2” means that there are two pieces of floating point-type 16-bit data, and “BOOL*1” means that there is one piece of bool-type data.

Note that the flow setting information 161 may include information that differs from the information illustrated in FIG. 6. For example, the flow setting information 161 may include a parameter that defines the content of the partial process. In one example, this parameter is a threshold used in rounding processing, an identifier of the device from which the data is to be collected, a cycle on which the data is to be collected, and an identifier of the device to which a control command is to be sent.

Returning to FIG. 5, the second receiver 170 is realized mainly by the processor 11. The second receiver 170 receives the settings of the system configuration from the UI 140 and sends system configuration information indicating the setting content to the device manager 180. The second receiver 170 functions as the second reception means recited in the claims.

The device manager 180 is realized mainly by cooperation between the processor 11 and the auxiliary storage 13. The device manager 180 acquires the system configuration information from the second receiver 170 and stores the acquired system configuration information. Additionally, the device manager 180 acquires, from the execution controller 120, execution information indicating the execution state of the process flow, and acquires, from the collectors 130, device information related to the devices 20 from which data is to be collected. Moreover, the device manager 180 provides, to the UI 140 via the second receiver 170, management information for displaying the acquired information and the configuration of the management system 100 on the UI 140. The device manager 180 functions as the device management means recited in the claims.

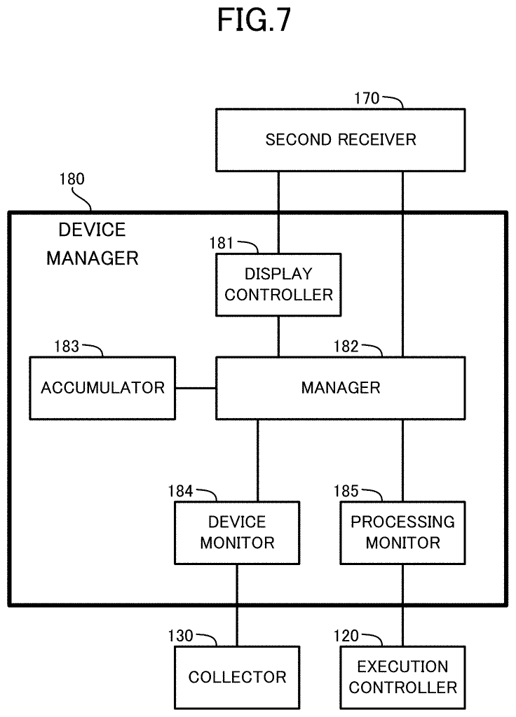

FIG. 7 illustrates the configuration of the device manager 180. As illustrated in FIG. 7, the device manager 180 includes a display controller 181 that sends the management information to the second receiver 170 to cause the UI 140 to display the management screen, a manager 182 that manages the system configuration information to generate the management information, an accumulator 183 that accumulates the system configuration information and information related to the execution state of the process flow, a device monitor 184 that acquires the device information from the collectors 130, and a process monitor 185 that acquires the execution information to monitor the execution state of the process flow.

The display controller 181 sends, to the second receiver 170, the management information output from the manager 182, and causes the UI 140 to display the content of the management information. The manager 182 acquires the system configuration information from the second receiver 170, and stores the system configuration information in the accumulator 183. Additionally, the manager 182 integrates the system configuration information stored in the accumulator 183, the device information acquired from the device monitor 184, and the execution information acquired from the process monitor 185 to generate management information for simultaneously displaying the system configuration and the execution state of the process flow. Moreover, the manager 182 sends the management information to the display controller 181.

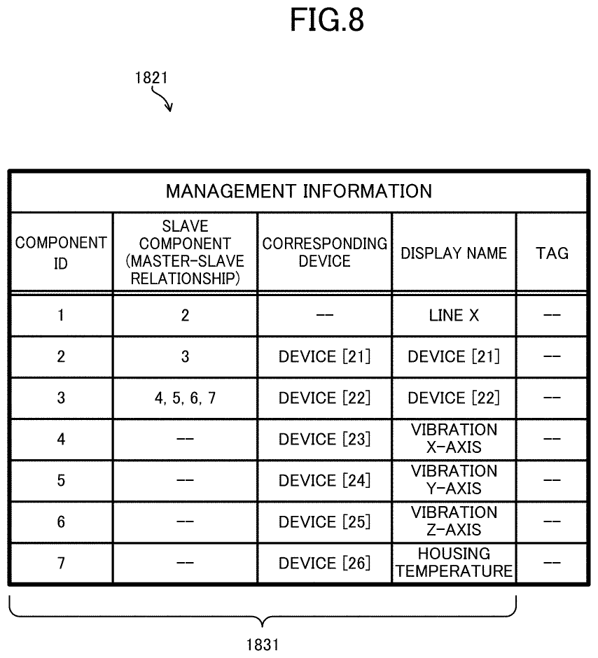

FIG. 8 illustrates an example of management information 1821. The management information 1821 is data in which an ID of a component displayed in correspondence with the device 20, an ID of a slave component of the component, a device corresponding to the component, a display name of the component, and a tag attached to the component are associated. Here, the components correspond to nodes that realize tree-like connection relationships such as illustrated in FIG. 3.

The term “slave component” refers to a lower level component that belongs to a single component. The master-slave relationship between the components is defined and the hierarchical structure of the management system 100 is determined based on the ID of the slave component. In one example, the component having the component ID “3” that corresponds to the device 22 has the component IDs “4”, “5”, “6”, and “7” as lower level components, and these lower level components respectively correspond to the devices 23 to 26. That is, as illustrated in FIG. 3, the device 22 is positioned on a higher level than the devices 23 to 26. The tag represents the execution information and the device information.

In the management information 1821, the section including the component ID, the slave component ID, the corresponding device, and the display name corresponds to system configuration information 1831. Since tags are not assigned to the components immediately after the system configuration is defined by the user, management information 1821 having empty tags, such as illustrated in FIG. 8, is stored in the accumulator 183 as the system configuration information 1831. Note that the tag may represent ancillary information input by the user.

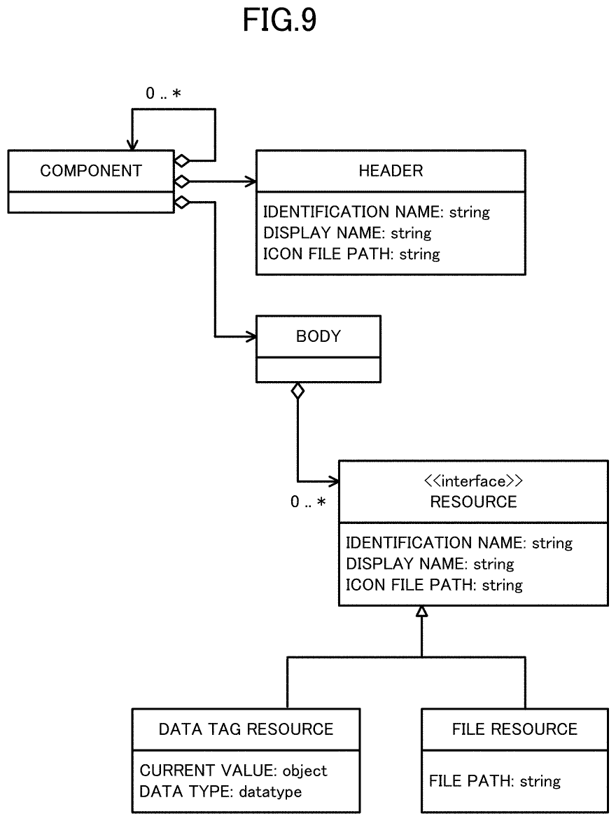

The data structure of the management information 1821 is not limited. For example, the management information 1821 may have a data structure such as illustrated in FIG. 9 to express the hierarchical relationships. The data structure illustrated in FIG. 9 is defined based on object linking and embedding for process control-undefined architecture (OPC-UA), and is a format for expressing a model that has a hierarchical structure. In FIG. 9, the arrows extending from the diamond shape marks express that the element at the end of the arrow belongs to the element at the base of the arrow. Additionally, the arrow extending from the triangle shape mark expresses that the element at the end of the arrow corresponds to one of a plurality of elements that are at the base of the arrow.

In this data structure, another component, a header, and a body belong to the component. The hierarchical relationships between the devices 20 are expressed by the other component belonging to the component that corresponds to the device 20. Note that other components do not belong to components that correspond to the end nodes of the tree illustrated in FIG. 3.

The header represents formal or additional information including the data sue of the component, and substantial information is stored in the body. In one example, the information included in the header is a component name for the management device 10 to handle the component in the internal processing, a component ID for identifying each component, a component display name for displaying the component on a screen, and a component icon file path indicating the location of data of an icon to be displayed on the screen. In FIG. 9, the data type of the “Identification name” that is the component ID, the component display name, and the component icon file path is “string.”

Resources belong to the body. The body is an element that bundles the resources. There are cases in which the body does not include resources, and also cases in which the body includes one or more resources. The resources correspond to at least one of a data tag resource and a file resource. However, there are cases in which a plurality of resources belongs to the body, and this plurality of resources includes both a data tag resource and a file resource.

The data tag resource represents the execution information and the device information. Specifically, in one example, the information included in the data tag resource is a resource ID for identifying the resource, a resource name for the management device 10 to handle the resource in the internal processing, a resource display name for displaying the resource on a screen, a resource icon file path indicating the location of data of an icon to be displayed on the screen, access destination information for the device manager 180 to carry out external access by communication, location address information indicating the location of the data, a current value that is a value acquired from the device at the access destination, the data type of the current value, and a number of characters to be used when the current value is string-type data. In one example, the access destination information is an IP address or a station code. The location address information corresponds to a device address that is handled by a programmable logic controller (PLC). The execution information and the device information can be said to be pieces of information that are primarily represented by the current value among the data tag resources. In FIG. 9, the data type of the “identification name” that is the resource ID, the resource display name, and the resource icon file path is “string”, and is indicated in the block called “Resource.” Additionally, it is indicated in the block called “data tag resource” that the data types of the current value and the data type included in the data tag resource are “object” and “datataype.”

The file resource represents information related to data in a case in which the component is file format data. In one example, the information included in the file resource is a resource ID for identifying the resource, a resource name for the management device 10 to handle the resource in the internal processing, a resource display name for displaying the resource on a screen, a resource icon file path indicating the location of data of an icon to be displayed on the screen, and a file path indicating the location of the file format data. FIG. 9 illustrates that the data type of the file path is “string.”

For example, if the process flow is being executed, the current value of the data tag resource is a string-type object called “Executing”, and the data type is string. The data type indicates various data types based on the content of the execution information and the device information and, for example, is bool, int, float, or string.

Returning to FIG. 7, the device monitor 184 monitors the collection state of data from the devices 20. Specifically, the device monitor 184 monitors whether the data that is the subject of the process flow is being collected from each of the devices 20 of the management system 100. Note that the device monitor 184 may perform other monitoring for the devices 20. For example, the device monitor 184 may monitor whether errors are output from the devices 20, or may monitor the connection states of the devices 20. The device monitor 184 may acquire the device information from the collectors 130 by a polling method in which the collectors 130 are periodically requested to send the device information, or may acquire the device information by a push method in which the collectors 130 autonomously send the device information periodically. The device monitor 184 sequentially sends the acquired device information to the manager 182.

The process monitor 185 monitors the execution state of the process flow. Specifically, the process monitor 185 monitors whether the process flow is being executed. Note that the process monitor 185 may perform other monitoring for the process flow. For example, the process monitor 185 may monitor whether there is an error in the execution of the process flow. The process monitor 185 may acquire the execution information from the execution controller 120 by a polling method in which the execution controller 120 is periodically requested to send the execution information, or may acquire the execution information by a push method in which the execution controller 120 autonomously sends the execution information periodically. The process monitor 185 sequentially sends the acquired execution information to the manager 182.

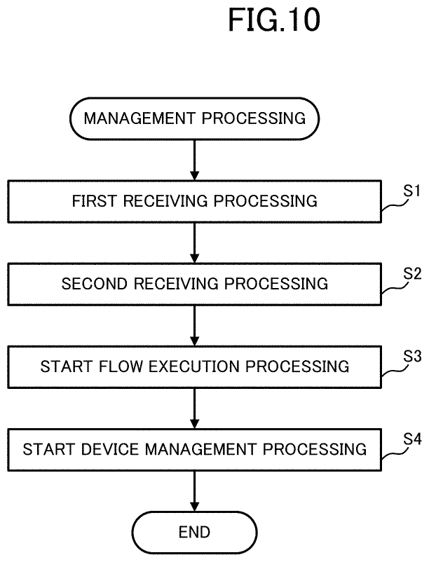

Next, the management processing executed by the management device 10 is described using FIGS. 10 to 22. The management processing illustrated in FIG. 10 starts when the power of the management device 10 is turned ON. Note that this management processing is not limited to being executed in the order illustrated in FIG. 10. However, for the sake of ease of comprehension of the description, an example is described in which the management processing illustrated in FIG. 10 is executed.

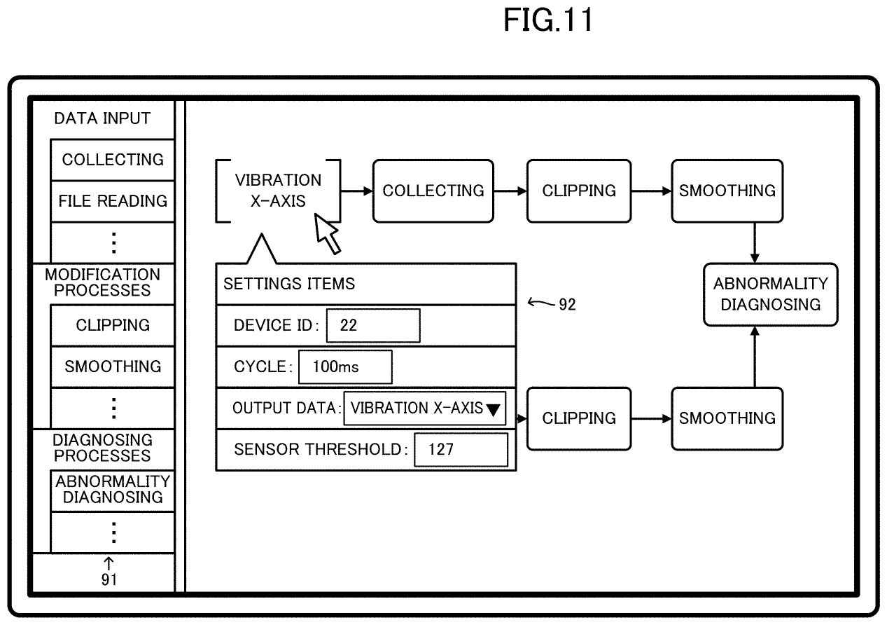

In the management processing, the first receiver 150 executes first receiving processing (step S1). Specifically, the first receiver 150 causes the UI 140 to display the screen illustrated in FIG. 11, and receives settings of the process flow that are input by the user. In this screen, the process flow can be input by placing blocks, selected from the left-side menu, on the right side by drag-and-drop operations, and connecting the blocks by arrows. Additionally, detailed settings can be input by using a sub-menu 92 that is displayed by selecting a block. Thus, the first receiver 150 receives the settings of the process flow and stores flow setting information such as illustrated in FIG. 6 in the storage 160. Note that the first receiving processing may be executed when the user sets the process flow at any timing. Step S1 corresponds to the first receiving step recited in the claims.

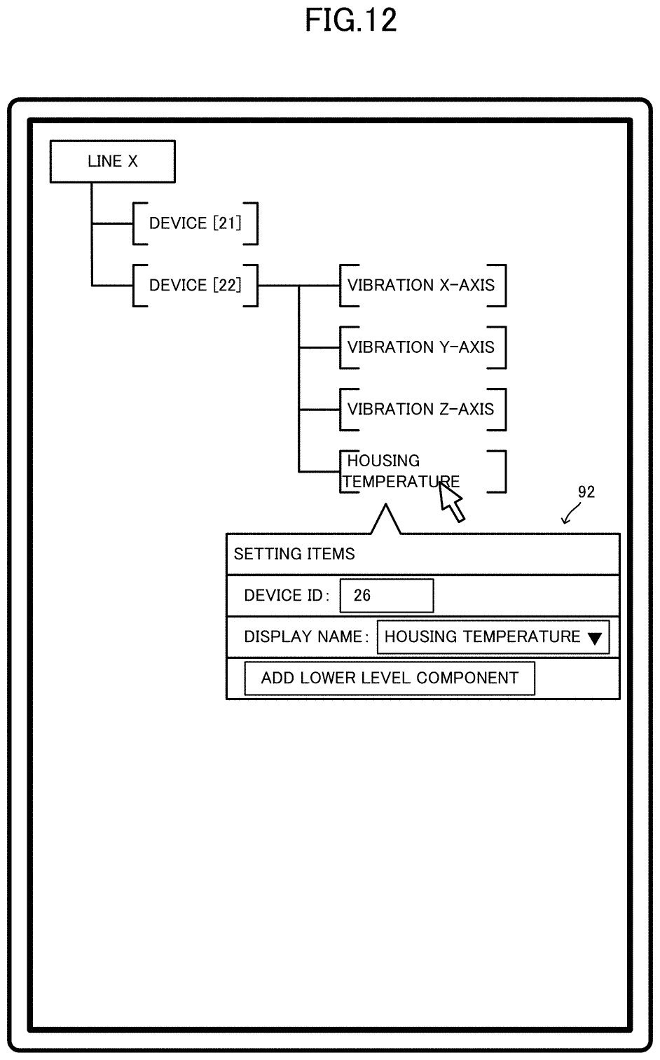

Returning to FIG. 10, after step S1, the second receiver 170 executes second receiving processing (step S2). Specifically, the second receiver 170 causes the UI 140 to display the screen illustrated in FIG. 12, and receives settings of the system configuration that are input by the user. In this screen, the device corresponding to the component and the display name are set from the menu 93 that is displayed by selecting the component, and the lower level components are added. As a result, the desired system configuration can be input. Thus, the second receiver 170 receives the settings of the process flow, and management information such as illustrated in FIG. 8 is stored in the accumulator 183 of the device manager 180. Note that the second receiving processing may be executed when the user sets the system configuration at any timing. Step S2 corresponds to the second receiving step recited in the claims.

Returning to FIG. 10, after step S2, the management device 10 starts flow execution processing (step S3), and starts device management processing (step S4). In the following, the flow execution processing and the device management processing are sequentially described.

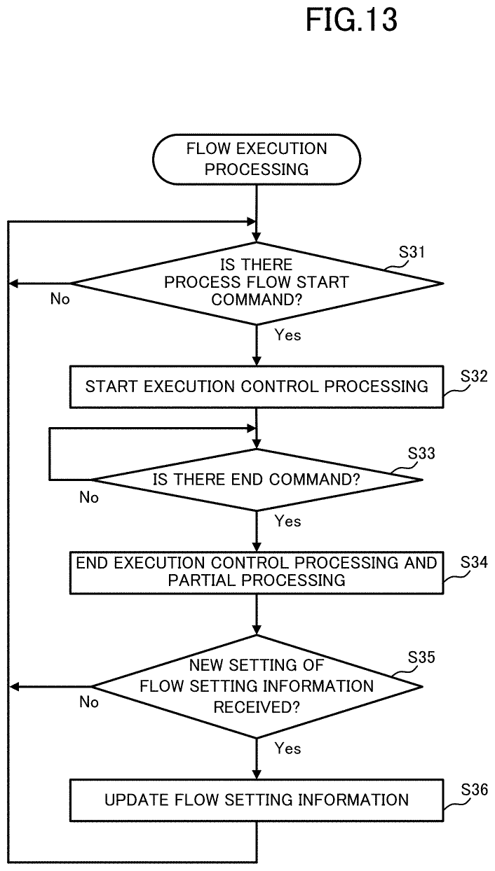

The flow execution processing is processing for executing the process flow, and is mainly executed by the processing units 110, the execution controller 120, and the collectors 130. The flow execution processing corresponds to the execution step recited in the claims. As illustrated in FIG. 13, in the flow execution processing, the management device 10 determines whether there is a process flow start command (step S31). Specifically, the execution controller 120 determines, in accordance with the settings received in the first receiving processing, whether there is a command indicating to start the process flow. This start command may be a command that is input by the user, or may be a trigger that occurs due to the arrival of a time defined by a predetermined schedule.

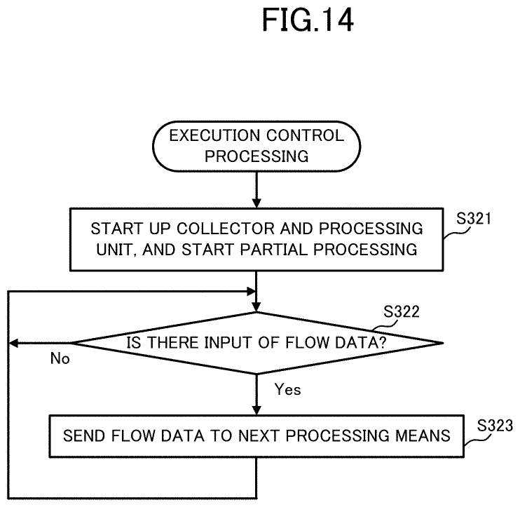

If it is determined that there is no start command (NO in step S31), the management device 10 repeats the determination of step S31, and waits until there is a start command. Meanwhile, if it is determined that there is a start command (YES in step S31), the management device 10 starts execution control processing (step S32). The execution control processing is processing in which the execution controller 120 transfers data between the processing units 110 and the collectors 130 in accordance with the flow setting information. This execution control processing is described using FIG. 14.

In the execution control processing, the execution controller 120 starts up all of the collectors 130 and the processing units 110 needed to execute the process flow, and starts partial processing (step S321). Specifically, the execution controller 120 references the flow setting information of the storage 160 to identify and start up the program that realizes the collectors 130 and the processing units 110 that execute the partial processes included in the process flow. As a result, the collectors 130 and the processing units 110 become capable of executing the partial processes.

Next, the execution controller 120 determines whether there is an input of flow data (step S322). Specifically, the execution controller 120 determines whether data according to the process flow is sent to the execution controller 120 from either of the processing units 110 and the collectors 130.

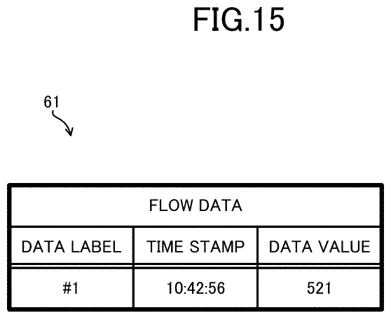

FIG. 15 illustrates an example of flow data 61. The flow data 61 is a table in which a data label given to the flow data, a time stamp indicating the time at which collection data corresponding to the flow data is collected from the devices 20, and a value of the data are associated. In this case, the collection data refers to data that is a target on which the process flow is performed. The data label corresponds to a label for identifying the arrows in FIG. 2. For example, the data label called “#1” is given to data that is output from the partial process 41 and input to the partial process 42 in FIG. 2. The time stamp indicates the time at which the collection data, which is to be subjected to the partial process to obtain the flow data, is collected. For example, in FIG. 2, the partial processes 42, 43 are sequentially performed on the collection data collected as a result of the execution of the partial process 41 at 10:42:56, and the time stamp of “10:42:56” is given to each piece of the flow data that is the output of these partial processes 42, 43. The values of the data indicate the results of the partial processes.

Returning to FIG. 14, if it is determined in step S322 that there is no input of flow data (NO in step S322), the execution controller 120 repeats the determination of step S322 and waits until flow data is input. Meanwhile, if it is determined that there is an input of flow data (YES in step S322), the execution controller 120 sends, in accordance with the flow setting information, the flow data determined as being input in step S322 to the processing unit 110 or the collector 130 that executes the next partial process (step S323). For example, in a case in which the process flow illustrated in FIG. 2 is executed, when flow data is input from the collector 130 that executes the partial process 41, the execution controller 120 sends this flow data to the processing unit 110 that executes the partial process 42. Additionally, when flow data is input from this processing unit 110, the execution controller 120 sends this flow data to the processing unit 110 that executes the partial process 43.

Returning to FIG. 13, after step S323, the execution controller 120 repeats the processing from step S322. Thus, the execution controller 120 can, according to the flow setting information, cause the processing units 110 and the collectors 130 to repeatedly execute the partial processes to be executed by the management device 10 of the process flow that includes the series of partial processes.

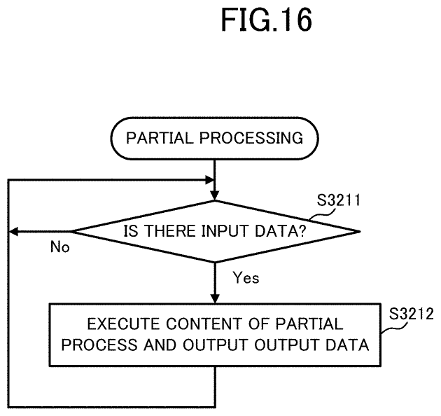

Next, the partial processing started in step S321 is described using FIG. 16. This partial processing is executed by the processing units 110 and the collectors 130. In the following example, the description focuses on partial processing executed by the processing units 110.

In the partial processing, the processing units 110 determine whether there is input data (step S3211). Specifically, the processing units 110 determine whether data sent from the execution controller 120 is input. However, in a case in which the partial processing is executed by the collectors 130, the collectors 130 determine whether there is data output from the devices 20.

If it is determined that there is no input data (NO in step S3211), the processing units 110 repeat the determination of step S3211, and wait until there is input data. Meanwhile, if it is determined that there is input data (YES in step S3211), the processing units 110 execute the content of the partial processing, and output data that represents the result of the partial processing to the execution controller 120 (step S3212). Then, the processing units 110 repeat the processing from step S3211.

As a result of the execution control processing and the partial processing described above, the management device 10 iteratively executes, in a semi-permanent manner, the process flow on data repeatedly output from the collectors 130 until there is an end command (described later).

It is described that the execution controller 120 causes the processing units 110 to execute the partial processes in the order specified in the flow setting information. This description is related to data acquired from devices by the collectors 130 at a certain timing. However, the order of execution of the partial processes regarding data that is repeatedly acquired is not limited thereto. Specifically, the order of execution of the partial processes by the processing units 110 for data acquired at different timings is not necessarily limited to the order defined by the process flow. For example, in a case in which the collectors 130 acquire data D1 at time t1 and data D2 at time 12, and a first partial process and a second partial process are respectively carried out on these pieces of data D1 and D2, the processing may be carried out in the order of the first partial process on the data D1, the second partial process on the result of this first partial process, the first partial process on the data D2, and the second partial process on the result of this first partial process; or the processing may be carried out in the order of the first partial process on the data D1, the first partial process on the data D2, the second partial process on the result of the first partial process of the data D1, and the second partial process on the result of the first partial process of the data D2.

Returning to FIG. 13, after step S32, the management device 10 determines whether there is a process flow end command (step S33). This end command may be a command that is input by the user, or may be a trigger that occurs due to the arrival of a time defined by a predetermined schedule.

If it is determined that there is no end command (NO in step S33), the management device 10 repeats the determination of step S33 and continues the execution control processing. Meanwhile, if it is determined that there is an end command (YES in step S33), the management device 10 ends the execution control processing and the partial processing (step S34). Specifically, the management device 10 ends the execution control processing that is started in step S32 and the partial processing started in this execution control processing.

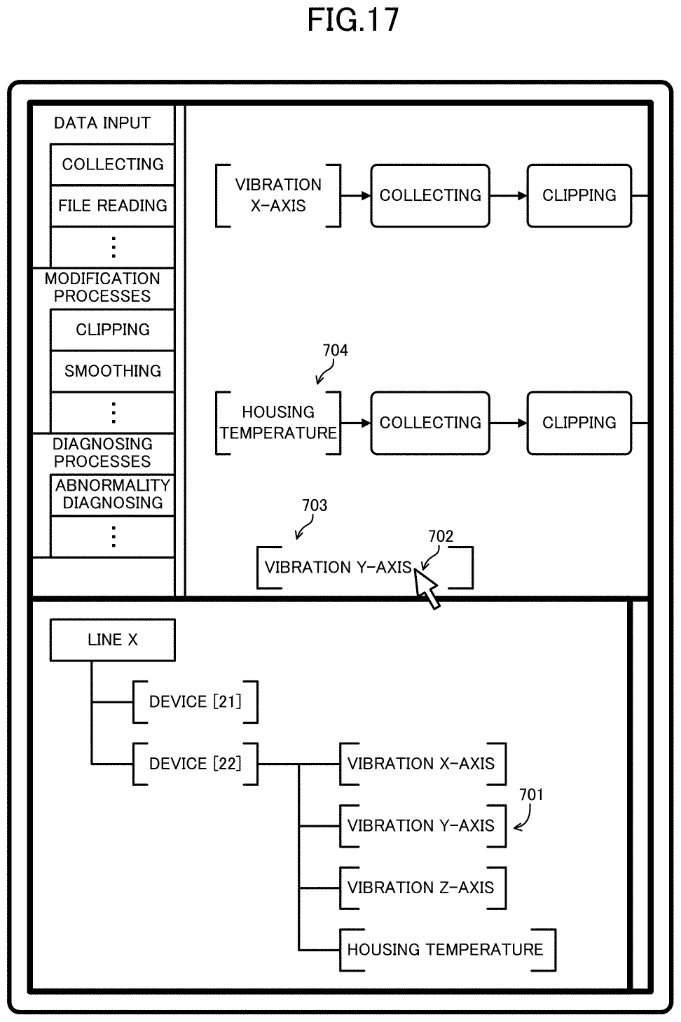

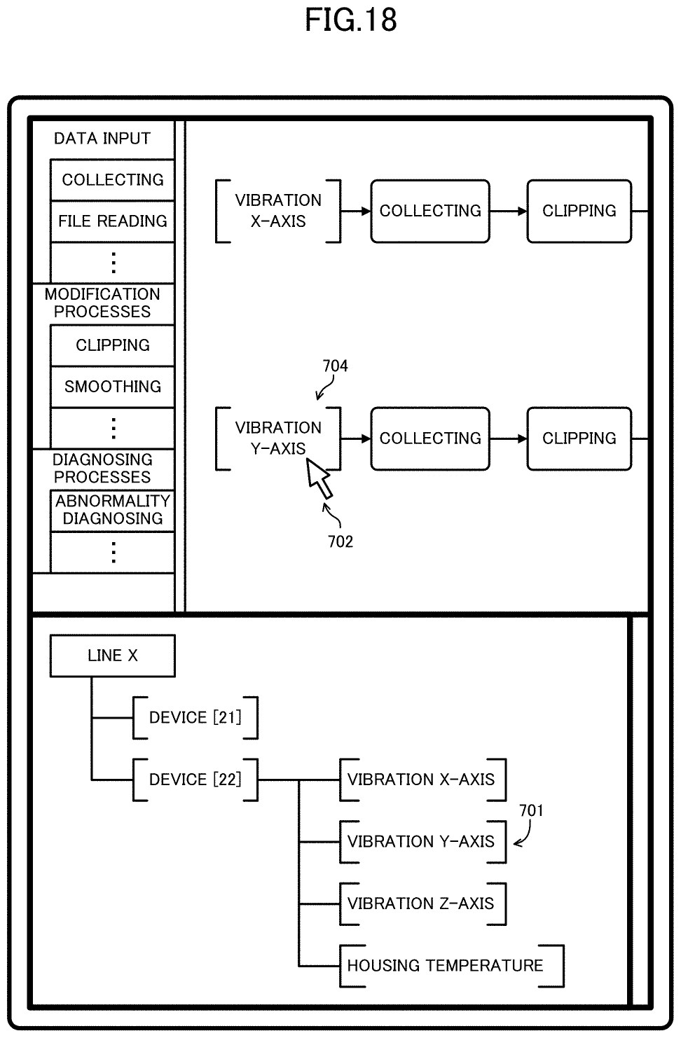

Next, the management device 10 determines whether a new setting of the flow setting information is received (step S35). Specifically, the first receiver 150 uses the management information to determine whether a new setting has been performed by the user. For example, as illustrated in FIG. 17, in a state in which a window for setting the process flow is arranged in the upper side of the screen and a window displaying the management information is arranged in the lower side of the screen, the user selects, using the cursor 702, the “Vibration Y-axis” block 701 displayed in the lower side, and moves the block 701 to the box 704 in the upper side by dragging and dropping, as illustrated in block 703. By performing such a drag and drop operation, as illustrated in FIG. 18, a setting is input for changing the collection data of the process flow from “housing temperature” to “Vibration Y-axis.” Note that the new setting received in step 35 may be a new setting of the process flow performed using the screen illustrated in FIG. 11.

Note that the setting change by the user of the process flow is input using the UI 140 at a desired timing of the user and, in step S35, the management device 10 simply determines whether there is a new setting. In a case in which a setting change of the process flow is input during the execution of the execution control processing, this input acts as a trigger that stops the execution control processing, the determination of step S33 is affirmed, the execution control processing is stopped, and the determination of step S35 is affirmed.

Returning to FIG. 13, if it is determined in step S35 that a new setting is not received (NO in step S35), the management device 10 repeats the processing from step S31. Meanwhile, if it is determined that a new setting is received (YES in step S35), the management device 10 updates the flow setting information according to the new setting received in step S35 (step S36). Specifically, the first receiver 150 notifies the execution controller 120 of the new setting content, and the execution controller 120 updates the flow setting information stored in the storage 160. For example, in a case in which the new setting illustrated in FIGS. 17 and 18 is input, the collection subject of the partial process 44 illustrated in FIG. 6 is changed from the device [26] to the device [24].

Returning to FIG. 13, after step S36, the management device 10 repeats the processing from step S31. As a result, the process flow including the series of partial processes is executed and new settings of the flow setting information are received when the process flow is stopped.

Next, the device management processing started in step S4 of FIG. 10 is described. The device management processing is processing for providing the user with management information for managing the plurality of devices 20, and is executed mainly by the second receiver 170 and the device manager 180. The device management processing is executed in parallel with the flow execution processing started in step S3. The device management processing corresponds to the provision step recited in the claims.

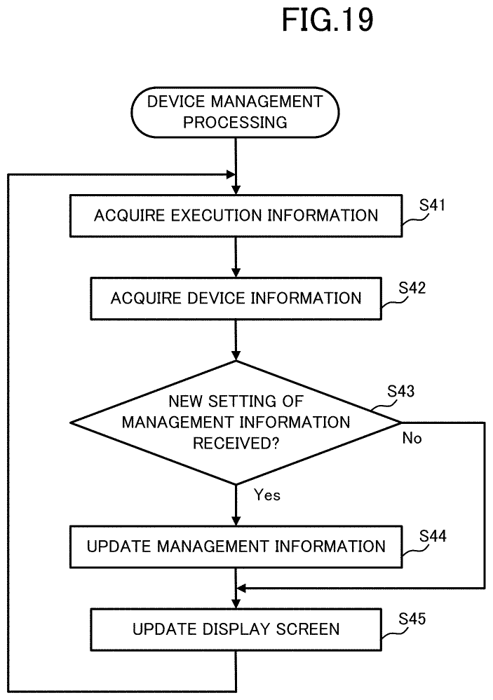

As illustrated in FIG. 19, in the device management processing, the device manager 180 acquires the execution information (step S41). Specifically, the process monitor 185 acquires, from the execution controller 120, the execution information related to the execution state of the process flow, and sends this execution information to the manager 182.

Next, the device manager 180 acquires the device information (step S42). Specifically, the device monitor 184 acquires, from the collectors 130, the device information related to the devices 20, and sends this device information to the manager 182.

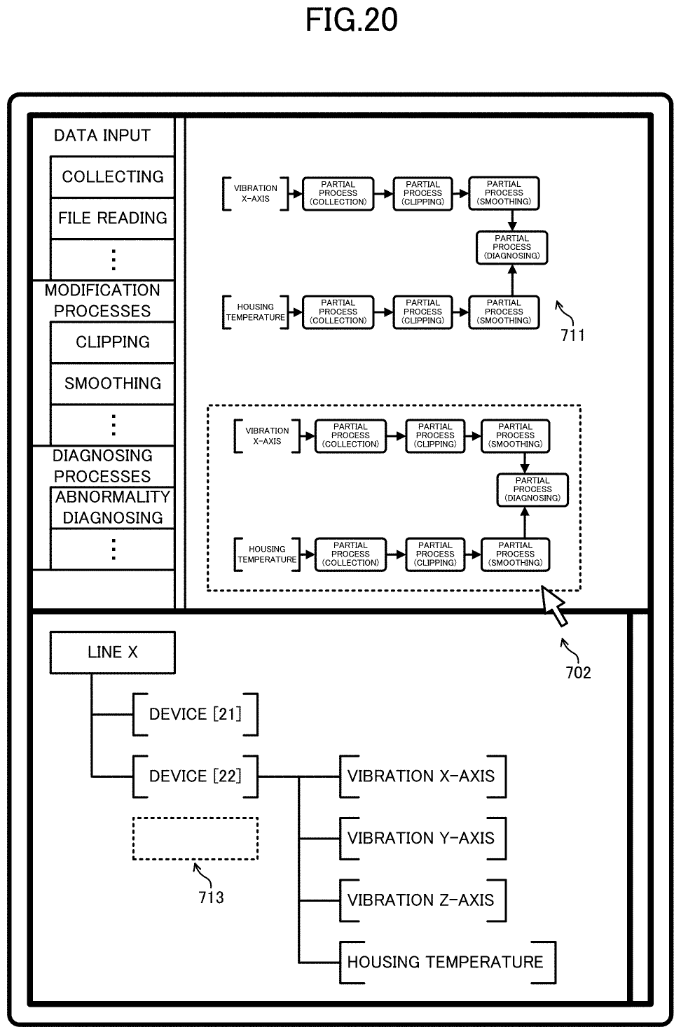

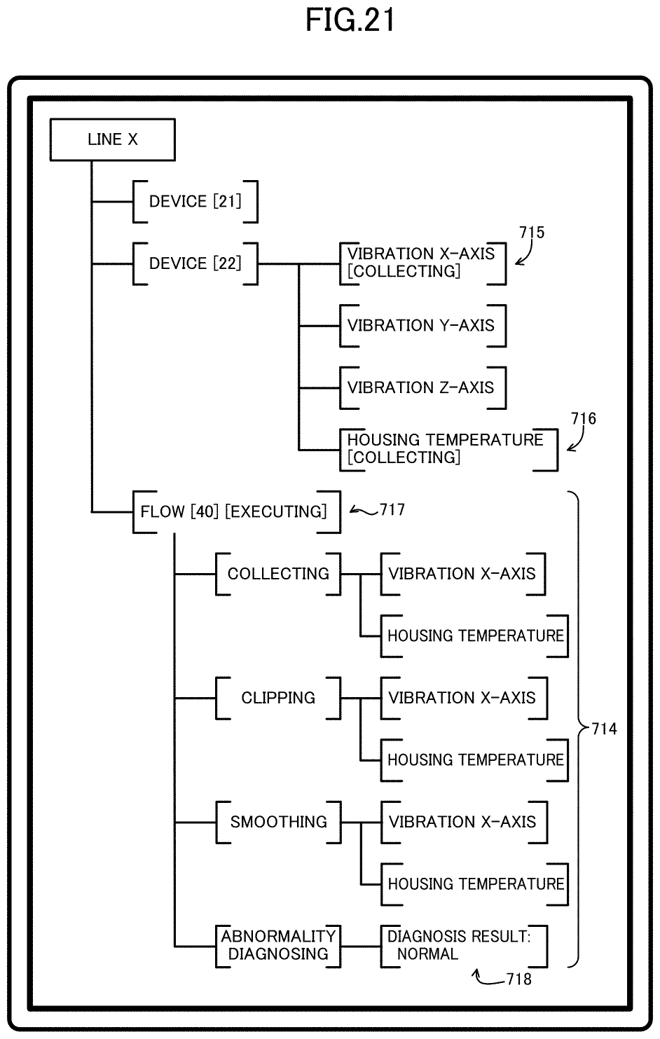

Next, the second receiver 170 determines whether a new setting of the management information is received (step S43). Specifically, the second receiver 170 uses the settings of the process flow to determine whether a setting has been performed by the user for displaying information related to the execution state of the processing on the management information display screen. For example, as illustrated in FIG. 20, the user uses the cursor 702 to drag and drop the entire process flow 711 displayed in the upper side of the screen, thereby moving the process flow 711 to an area 713 in the lower side of the screen directly under the “device [22].” As a result of this drag and drop operation, as illustrated in FIG. 21, a component group 714 that displays the execution state of the process flow is generated on the same level as the component called “device [22].” Note that the new setting received in step S43 may be a new setting of the system configuration performed using the screen illustrated in FIG. 12.

Note that the management information setting change by the user is input using the UI 140 at a desired timing of the user and, in step S43, the management device 10 simply determines whether there is a new setting.

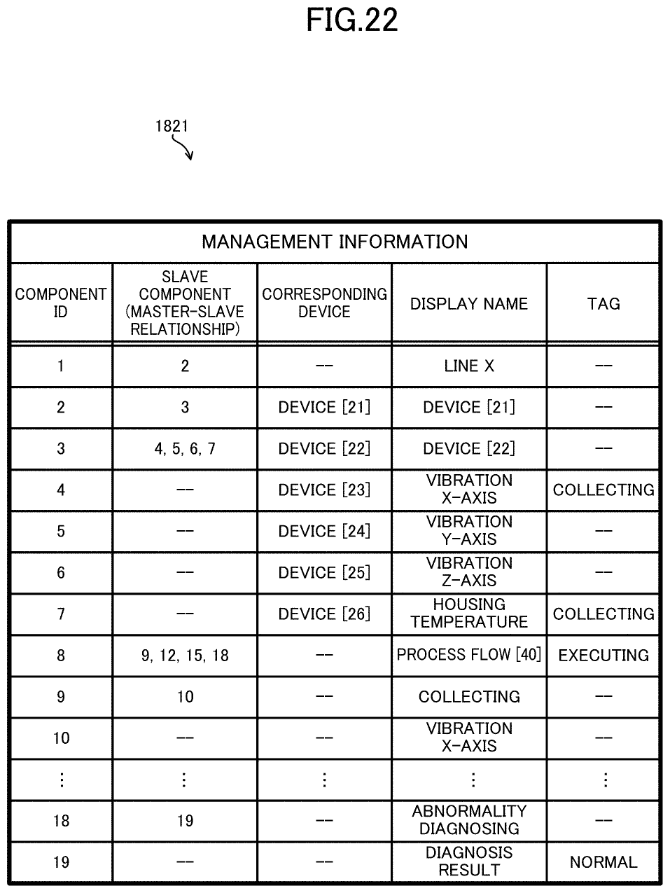

Returning to FIG. 19, if it is determined in step S43 that a new setting is not received (NO in step S43), the device manager 180 transitions to the processing to step S45. Meanwhile, if it is determined that a new setting is received (YES in step S43), the device manager 180 updates the management information according to the new setting received in step S43 (step S44). Specifically, the second receiver 170 notifies the device manager 180 of the new setting content, and the manager 182 updates the management information stored in the accumulator 183. For example, in a case in which the new setting illustrated in FIG. 20 is input, the management information illustrated in FIG. 6 is updated and, as illustrated in FIG. 22, includes a component for carrying out a display related to the process flow.

Returning to FIG. 19, after step S44, the device manager 180 updates the display screen that displays the management information (step S45). Specifically, the display controller 181 updates, based on the information acquired in steps S41 and S42 and the new setting received in step S43, the content displayed on the management screen. Thus, as illustrated in FIG. 21, device information called “Collecting” is displayed for the components 715 and 716, and execution information called “Executing” is displayed for the component 717.

Returning to FIG. 19, after step S45, the device manager 180 repeats the processing from step S41. Thus, the system configuration is set as desired by the user, and management information is provided that includes execution information related to the execution state of the process flow and device information. Additionally, the management information is updated as needed according to the execution state of the process flow.

As described above, management information is provided for displaying the hierarchical relationships of the plurality of devices 20 and for displaying information related to the execution state of the processing. As such, the user can easily manage the plurality of devices 20 and the execution state of the processing related to the plurality of devices 20. As a result, the management burden of the user can be lightened.

The management information includes the execution information that indicates whether the process flow is being executed. As such, the user can easily recognize whether the process flow is being executed and can manage the management system 100.

The management information includes the device information that indicates whether the data output from the devices 20 is to be subjected to the process flow. As such, the user can easily recognize which devices 20 of the plurality of devices 20 are involved in the process flow, and can manage the management system 100.

The first receiver 150 newly receives process flow settings using the management information. As such, the user can more easily set the process flow while referencing the management information.

The second receiver 170 newly receives the setting for displaying the management information using the process flow settings. As a result, the user can more easily change the management information while referencing the process flow settings.

The hierarchical relationships of the plurality of devices 20 are displayed in a tree-like manner. As a result, the user can easily recognize the hierarchical relationships of the plurality of devices 20.

The management information has a data structure for expressing the hierarchical relationships and, in this data structure, another component and a body belong to the component corresponding to the device, and a data tag resource belongs to the body. The data tag resource represents the device information and the execution information. As a result, the hierarchical relationships can be easily managed and changes thereto are easier.

An embodiment of the present disclosure is described above, but the present disclosure is not limited by the embodiment described above.

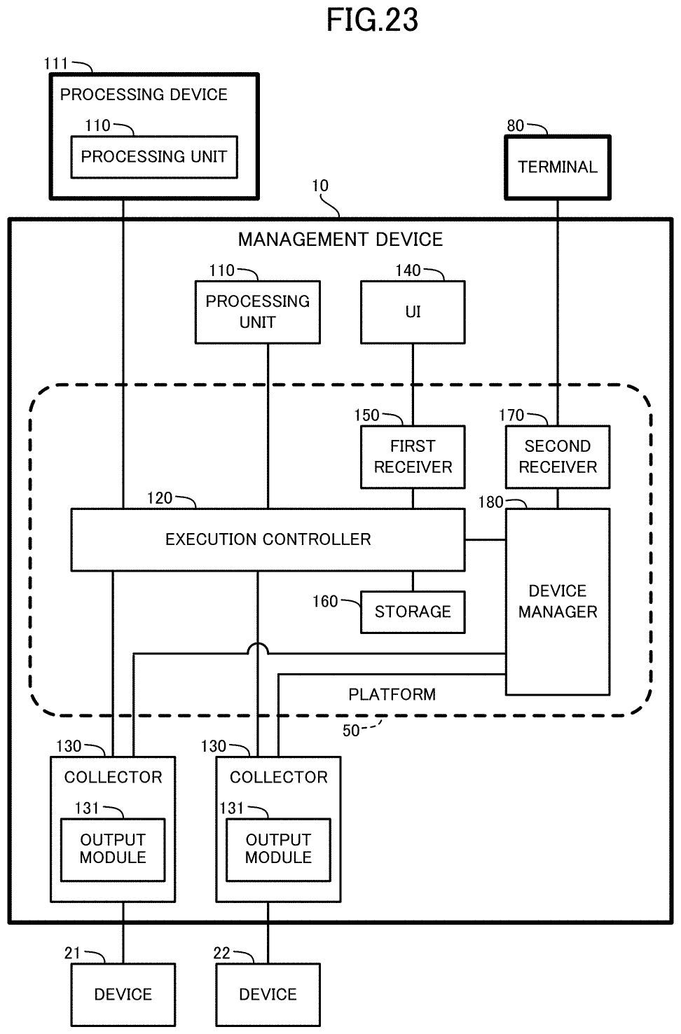

For example, the platform 50 illustrated in FIG. 5 is provided as the operating environment for executing the process flow and managing the devices 20. As such, as illustrated in FIG. 23, for example, even if an external terminal 80 is connected to the platform 50 instead of the UI 140 and an external processing device 111 including a part of the plurality of processing units 110 or all of the processing units 110 is connected to the platform 50, functions equivalent to those of the management device 10 described above can be achieved.

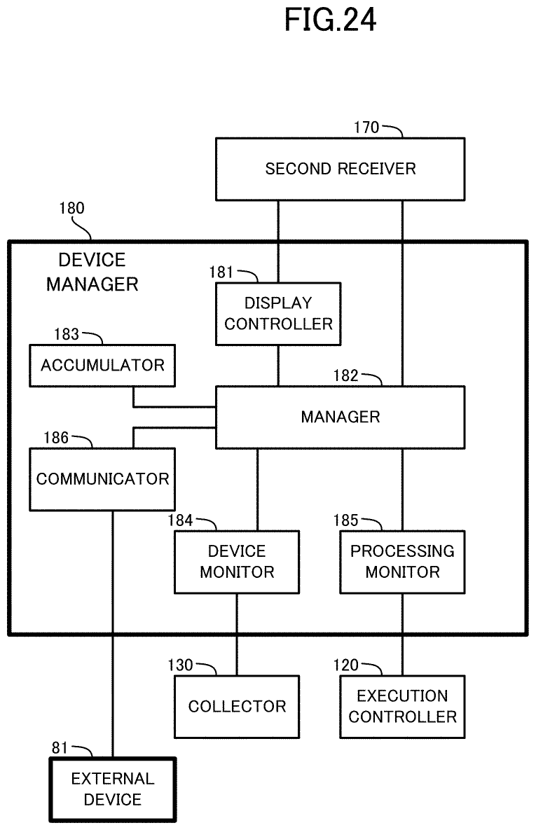

As illustrated in FIG. 24, a configuration is possible in which the device manager 180 includes a communicator 186 for communicating with an external device 81 and manages the plurality of devices 20 in cooperation with the external device 81. For example, a configuration is possible in which some devices 20 of the plurality of devices 20 are managed by the management device 10, and the other devices 20 are managed by the external device 81.

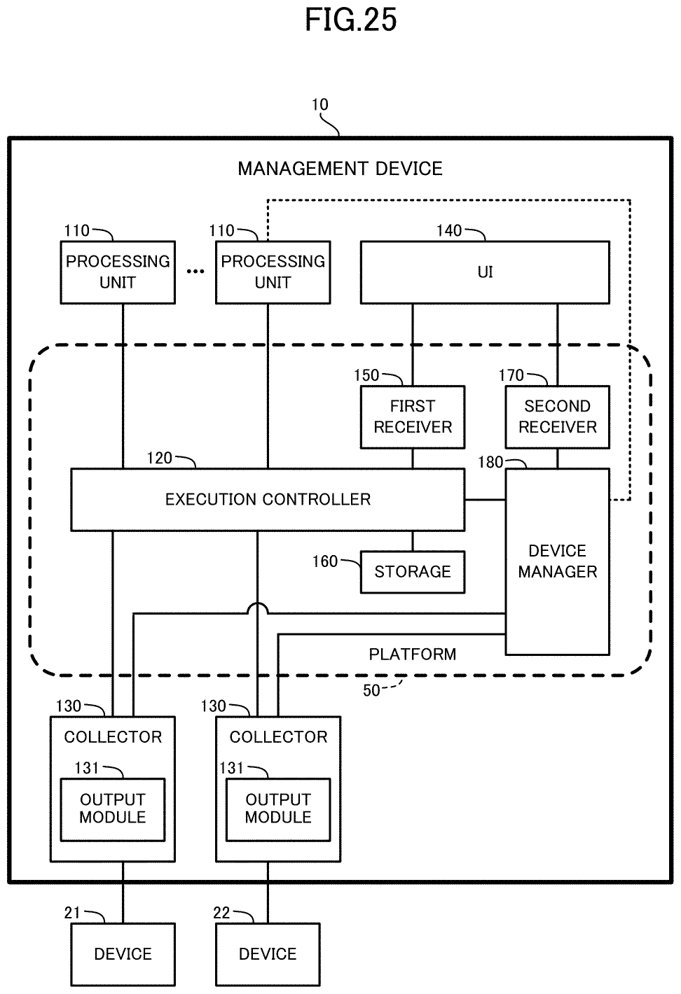

As illustrated in FIG. 25, a configuration is possible in which the device manager 180 is connected to a processing unit 110. Moreover, the device manager 180 may provide the management information to the processing unit 110. For example, a case is assumed in which the partial processes executed by the processing units 110 include selecting one device 20 from the plurality of devices 20 and acquiring the device information. In this case, the processing unit 110 may acquire the management information by requesting the management information from the device manager 180, select the device 20 based on the acquired management information and, as needed, acquire the device information related to the selected device 20 from the device manager 180. In this case, the data structure illustrated in FIG. 9 corresponds to an interface between the processing unit 110 and the device manager 180.

A configuration is possible in which the management information includes other information in addition to the system configuration, the device information, and the execution information. For example, parameters set for the devices 20 may be included as lower level components of the devices 20. Additionally, as with component 718 of FIG. 21, a data value representing the result of the partial process may be displayed on the management screen.

The functions of the management device 10 can by realized by dedicated hardware or by a typical computer system.

For example, the program P1 executed by the processor 11 can be stored and distributed on a non-transitory computer-readable recording medium, and a device that executes the processing described above can be configured by installing that program P1 on a computer. Examples of such a recording medium include a flexible disc, a compact disc read-only memory (CD-ROM), a digital versatile disc (DVD), and a magneto-optical disc (MO).

A configuration is possible in which the program P1 is stored on a disc device of a server device installed on a communication network such as the interne, and downloaded to a computer by being superimposed on a carrier wave.

The processing described above can also be achieved by starting up and executing the program P1 while transferring the program P1 via the communication network.

Furthermore, the processing described above can also be achieved by causing a portion or the entirety of the program P1 to be executed on a server device, and executing the program while the computer sends and receives information related to the processing of the program P1 via the communication network.

Note that, in cases in which the functions described above are realized in part by an operating system (OS), or the functions are realized by cooperation between an OS and an application, it is possible to store and distribute only the portion other than the OS on the medium, or download the portion other than the OS to a computer.

The means whereby the functions of the management device 10 are realized are not limited to software, and a portion or the entirety of the functions may be realized by dedicated hardware including circuits.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitable for managing a plurality of devices related to data processing.

### REFERENCE SIGNS LIST

100 Management system

10 Management device

### 11 Processor

12 Main storage
13 Auxiliary storage

### 14 Inputter

### 15 Outputter

### 16 Communicator

### 17 Internal bus

110 Processing unit
111 Processing device
120 Execution controller

### 130 Collector

131 Output module

### 140 UI

150 First receiver

### 160 Storage

161 Flow setting information
170 Second receiver
180 Device manager
181 Display controller

### 182 Manager

1821 Management information
1831 System configuration information

### 183 Accumulator

184 Device monitor
185 Processing monitor

### 186 Communicator

### 20 to 26 Device

30 Communication path

### 31 Bus

40 Process flow
41 to 47 Partial process

### 50 Platform

61 Flow data

### 701, 703 Block

### 702 Cursor

### 704 Box

711 Process flow

### 713 Area

714 Component group

### 715 to 718 Component

### 80 Terminal

81 External device

### 92 Submenu

### 93 Menu

### P1 Program

### U1 User

1. A management device to be connected to a plurality of devices, the management device comprising:
a first receiver to receive a setting of processing to be performed on data output from at least one of the plurality of devices;
an execution controller to cause a processor to execute the processing with the setting received by the first receiver;
a second receiver to receive a setting of a hierarchical relationship of the plurality of devices; and
a device manager to provide management information for displaying (i) the hierarchical relationship of the plurality of devices in accordance with the setting received by the second receiver and (ii) information related to an execution state of the processing.

2. The management device according to claim 1, wherein
the information related to the execution state of the processing includes execution information indicating whether the processing is being executed, and
the device manager acquires the execution information from the execution controller, to provide the management information.

3. The management device according to claim 1, further comprising:
a collector to collect data output from at least one of the plurality of devices,
wherein
the information related to the execution state of the processing includes device information indicating whether the data output from the device is a subject of the processing, and
the device manager acquires the device information from the collector to provide the management information.

4. The management device according to claim 1, wherein the first receiver newly receives a setting of the processing, the setting using the management information provided by the device manager.

5. The management device according to claim 1, wherein the second receiver newly receives a setting for displaying the information related to the execution state of the processing, the setting using the setting received by the first receiver.

6. The management device according to claim 1, wherein the management information is information for displaying the hierarchical relationship of the plurality of devices in a tree-like manner.

7. The management device according to claim 1, wherein
the management information is data that has a predefined structure for expressing the hierarchical relationship,
the structure is a structure including a component corresponding to the device, in which another component and a body belong to the component, and a data tag resource belongs to the body, and
the data tag resource represents the information related to the execution state of the processing.

8. A management method comprising:
receiving a first setting of a processing to be performed on data output from at least one of a plurality of devices;
executing the processing with the received first setting;
receiving a second setting that defines a hierarchical relationship of the plurality of devices; and
providing management information for displaying (i) the hierarchical relationship of the plurality of devices defined by the received second setting and (ii) information related to an execution state of the processing.

9. A non-transitory computer-readable recording medium storing a program that causes a computer to function as:
a first receiver to receive a setting of processing to be performed on data output from at least one of a plurality of devices;
an execution controller to cause a processor to execute the processing with the setting received by the first receiver;
a second receiver to receive a setting that defines a hierarchical relationship of the plurality of devices; and
a device manager to provide management information for displaying (i) the hierarchical relationship of the plurality of devices defined by the setting received by the second receiver and (ii) information related to an execution state of the processing.
